(19) United States
(12) Patent Application Publication
(10) Pub. No.: US 2007/0228078 A1
(43) Pub. Date: Oct. 4, 2007

(54) SWITCHBACK SHUTE FOR MATERIAL HANDLING

(75) Inventor: Irl R. Sanders, Milford, CT (US)

Correspondence Address: LAW OFFICE OF DELIO & PETERSON, LLC., 121 WHITNEY AVENUE, 3RD FLLOR, NEW HAVEN, CT, 06510, US

(73) Assignee: KX INDUSTRIES, Orange, CT (US)

(21) Appl. No.: 11/690,517

(22) Filed: Mar. 23, 2007

Related U.S. Application Data
(62) Division of application No. 10/984,623, filed on Nov. 9, 2004.

(51) Int. Cl. B65D 88/26; B67D 5/62

(52) U.S. Cl. 222/146.1; 222/460

(57) ABSTRACT

A chute that minimizes segregation during the delivery of bulk material via gravity from a higher location to a lower location, has a plurality of surfaces arranged vertically, one substantially below the next, and directed such that some or all of the adjacent surfaces cause the bulk material transiting the chute to frequently stop its forward motion momentarily, and then change direction or switch back. The directing surfaces may be flat, curved, conical, or partially conical in shape, with a combination of truncated cones and complete cones, or all truncated cones. An optional second set of truncated cone segments is introduced on the top of one or more of the converging cones in order to contain any overflow due to surges of material. A set of auxiliary outboard cones associated with respective converging cones is designed to reduce the freefall distance when the converging cones overflow by design.

### BACKGROUND OF THE INVENTION

1. Field of the Invention

The invention relates generally to gravity flow storage bins, containers, and the like, for bulk particle solids. More particularly, the invention relates to a chute design for delivering bulk particle solids in a manner that significantly reduces or eliminates particle segregation.

2. Description of Related Art

Severe segregation problems can occur when filling storage bins and other containers with free flowing bulk solids such as powders, granules, pellets, and mixtures of different materials, when the bulk material contains both fine and larger particles, or when with mixtures of particles have differing physical properties, such as density, shape, friction with other surfaces, and cohesion. Segregation is most predominant when the material is allowed to freefall from the top of a bin or container and impacts the pile of material building below the entry point.

Segregation can also occur as material slides down a chute, when chutes are used to introduce the material to the bin in a slower fashion. Chute related segregation might occur both within the chute arrangement itself and during exit from the chute before the particles come to rest in the building pile of material at the bottom of the bin.

Typically, pockets or areas of excess fine particles and areas deficient in fine particles will exist in the pile in the bin. The same will be true of the heavier or larger particles, or particles having different character.

If bulk material is allowed to fall freely, numerous mechanisms may cause segregation problems. The smaller particles float and remain in the air for a longer time—a process known as air entrainment/aeration. The larger, heavier freefalling particles, if allowed to freefall over a long distance, accelerate rapidly due to gravity, until they abruptly impact the pile with force, transferring momentum to the fine particles in the center of the pile, lifting them upward and outward. This process causes the fine particles to become fluidized. Fluidized fine powder acts more like a liquid with respect to its flow properties. The outward-blasted fine particles tend to accumulate along the walls of the bin, and the upward-blasted fine particles, commonly referred to as “dust”, tend to spread out and form a layer of dust on top of the primary pile of material. This upper layer of fine particles may become very thick by the time the bin is completely filled. These various collisions result in an excess of heavy particles in a column in the center of the bin, with fine particles accumulated near the walls of the bin, and a very detrimental layer of fine particles on top of the pile. In addition, heavy particles can cause various patterns of segregation if they slide or bounce down on the conically shaped surface of the pile.

The kinetic energy difference of an object that is allowed to freefall from the top of a bin verses a controlled velocity letdown is extremely large. For example, if the maximum allowed freefall is six inches, then a particle will obtain a terminal velocity of about 5.7 feet/second, ignoring air resistance. The terminal velocity of a particle that is allowed to freefall 10 feet from the top of a bin is approximately 25.3 feet/second, or about 4.4 times faster.

The kinetic energy of the slower moving particles in a chute designed to minimize velocity, where the particles are only allowed to freefall about 6 inches at a time before stopping is about 20 times less than the same particle falling a full 10 foot freefall drop, and traveling 4.4 times faster than the controlled particle at the end of its fall when it impacts the pile. A larger particle in the mixture may be 50 times heavier than a fine particle, thus having 1000 times more kinetic energy than the fine particle. Thus, disruption of the fine particles and severe fluidization segregation problems can occur when employing a conventional chute that does not have velocity control features. Importantly, these problems can be minimized if particle velocity is controlled.

In addition to bin filling, there remain many other applications where it is necessary to convey bulk material from a higher to a lower location, also known as “letdown”, for which the segregation issue is relevant.

Numerous bin-filling or letdown chute designs have been proposed in attempts to minimize segregation, dusting, product damage, and other problems that occur if bulk materials are allowed to free-fall when loaded into a storage or transport container. These designs include spiral slide arrangements, and back-and-forth cascading slide arrangements. These designs appear to slow the rate of descent of the failing particles, in contrast to a freefall situation, by lengthening the path traveled from the entrance of the bin to the bottom. Most of these designs also appear to rely, to some extent, on slowing the material by the friction of the particles against the chute surface.

Some inherent segregation problems exist with prior art sliding type chute designs, including:
a) sifting segregation, where small fine particles tend to sift downward through the mass of material and congregate along the surface of the chute while the larger particles stay in a top layer;
b) sliding segregation, where the heavier particles slide ahead on the top of the finer particles that are dragging on the surface of the chute and thus separate from the smaller particles;
c) air friction (air entrainment/aeration), where the flow of the lighter particles is impeded by friction with the air at the chute discharge area, making the lighter particles fall closer to the chute exit, while the trajectory of the larger heavier particles, which will have more momentum, is projected outwards and lands them further away; and
d) since most chutes discharge the material at an angle from the horizontal, some of the particles with more mass tend to bounce or skip and slide further down the building pile, towards the outside walls of the bin, while the lighter particles remain nearer the top of the pile and towards the center of the bin. This phenomenon may also occur when heavy particles join the pile from a more vertical direction.

Furthermore, with conventional sliding chute designs, if the end of the chute contacts the pile material, particle flow may stall and backup on the chute. The material that was stalled on the slide does not restart on its own once the end of the chute is cleared unless the angle of the slide is steep, or mechanical action, such as vibration, was applied to the chute.

In U.S. Pat. No. 1,207,763 issued to Jaeger on Dec. 12, 1916, entitled, “APPARATUS FOR TREATING GRAINS,” a complex arrangement of tanks and screens is claimed to cause changes to grain as the grain passes through it. A portion of the apparatus uses screens in the form of alternating upright and inverted frusto-conical cones intended to scatter the grains and have them roll down the screens. The screens allow for fine particles to fall through and separate from the larger particles causing segregation.

In U.S. Pat. No. 1,218,250 issued to J. Fox on Mar. 6, 1917, entitled, “GRAIN PICKLER,” a tank and pipe combination is claimed for discharging treatment liquid in order to destroy smut by thoroughly sprinkling and mixing the grain to expose all of the grains to a treating agent. The apparatus is optimized to disperse the grain, and as such, it intentionally causes disruption of the grains to separate them. The Fox apparatus requires steep sides for its cones, too steep to effectively slow the descent of material for anti-segregation purposes.

In U.S. Pat. No. 1,224,656 issued to E. S. McCandliss on May 1, 1917, entitled, “CONCRETE MIXER,” vertically aligned cones with upwards pointing cones situated to seal off downwards pointing cones, form valves for progressively releasing a batch of concrete into the next lower chamber, one chamber at a time. No anti-segregation features are claimed, taught, suggested, or disclosed. Stratification of fine and coarse material is promoted as the material leaves an upper hopper and strikes the inclined walls of the lower hopper beneath it.

In U.S. Pat. No. 1,415,830 issued to M. M. Fredel, et al., on Jul. 5, 1921, entitled, “AGITATOR,” an apparatus designed to agitate flour is claimed. It is operated to create a completely closed, hollow wall formation and to maintain the hollow wall formation during the agitating and bleaching process. Due to specific design features, the agitator is not suitable for segregation purposes.

The above-mentioned examples indicate that the prior art lacks effective bin-filling letdown chutes for material that tends to segregate. Some existing, commercially available chutes, intended for vertical letdown of bulk materials require a sensor-controlled motorized hoist system to raise and collapse or telescope the sections of the chute during conveying operations in order to keep the chute clear of the pile and maintain flow. This type of design is more expensive, complicated, and more difficult to incorporate in a bin than a static/stationary chute, and may require significantly more maintenance than a static/stationary chute. Also, installation of mechanically manipulated motorized chutes generally requires a significant retrofit to the bin.

Bearing in mind the problems and deficiencies of the prior art, it is therefore an object of the present invention to provide a chute design that minimizes segregation of particles.

It is another object of the present invention to provide a chute design that is simple to manufacture and install, inexpensive and requires little maintenance, and will allow for bin filling and other letdown conveying applications with minimal segregation.

A further object of the invention is to provide a chute design for minimizing segregation without requiring any moving parts.

It is yet another object of the present invention to provide a chute design for minimizing segregation without requiring human intervention or automation control systems during letdown.

Another object of the present invention is to provide a chute design that minimizes segregation with minimal bin modification, if any, to install.

A further object of the present invention is to provide a chute design that inherently corrects for minor segregation occurring in the systems used to mix and deliver material to the chute and to reverse segregation that may occur in the chute itself.

It is yet another object of the present invention to provide a chute design for minimizing segregation that may be permanently installed inside a storage container.

Still other objects and advantages of the invention will in part be obvious and will in part be apparent from the specification.

### SUMMARY OF THE INVENTION

The above and other objects, which will be apparent to those skilled in art, are achieved in the present invention, which is directed to a chute for conveying bulk material or liquid from a higher location to a lower location, the chute comprising: a plurality of converging cones truncated with openings at top and bottom, each of the converging cones having an inner surface, an apex pointing downwards, and a first apex angle; a plurality of diverging cones, each diverging cone corresponding to one of the plurality of converging cones, the diverging cones having an outer surface, an apex pointing upwards, and a second apex angle; the converging and diverging cones vertically aligned and arranged in alternating downwards and upwards directions with one cone below the next, each of the diverging cones spaced from the converging cone inner surface, the bulk material or liquid transiting the chute follows a path formed by the converging cone inner surface and the diverging cone outer surface, and substantially slows down or stops forward motion when contacting each subsequent cone, changes direction, and continues down the chute; and a support structure for vertically aligning and securing in place the converging cones and the diverging cones, the structure peripherally open to the container.

The first apex angle and the second apex angle may be in combination with one another such that a projection of the converging cone inner surface plane intersects with and is approximately perpendicular to a next lower diverging cone outer surface or a projection of the next lower diverging cone outer surface, and a projection of the diverging cone outer surface plane intersects with and is approximately perpendicular to a next lower converging cone inner surface or a projection of the next lower converging cone inner surface.

In a second aspect, the present invention is directed to a chute for conveying bulk material or liquid from a higher location to a lower location, the chute comprising: a plurality of converging cones truncated with openings at top and bottom, each of the converging cones having an inner surface, an apex pointing downwards, and a first apex angle; a first set of diverging cones, each diverging cone corresponding to one of the plurality of converging cones, the diverging cones having an outer surface, an apex pointing upwards, and a second apex angle; the converging and diverging cones vertically aligned and arranged in alternating downwards and upwards directions with one cone below the next, each of the diverging cones spaced from the converging cone inner surface, the bulk material or liquid transiting the chute follows a path formed by the converging cone inner surface and the diverging cone outer surface, and substantially slows down or stops forward motion when contacting each subsequent cone, changes direction, and continues down the chute; a set of top reverse deflector cones truncated on top and bottom and in peripheral contact with the top of one or more of the converging cones to contain dust and overflow material; and a support structure for vertically aligning and securing in place the converging cones and the first and second sets of diverging cones, the structure peripherally open to the container.

In a third aspect, the present invention is directed to a chute for conveying bulk material or liquid from a higher location to a lower location, the chute comprising: a first set of converging cones truncated with openings at top and bottom, each of the converging cones having an inner surface, an apex pointing downwards, and a first apex angle; a plurality of diverging cones, each diverging cone corresponding to one of the first set of converging cones, the diverging cones having an outer surface, an apex pointing upwards, and a second apex angle; the converging and diverging cones vertically aligned and arranged in alternating downwards and upwards directions with one cone below the next, such that a projection of the converging cone inner surface plane intersects with and is approximately perpendicular to a next lower diverging cone outer surface or a projection of the next lower diverging cone outer surface, and a projection of the diverging cone outer surface plane intersects with and is approximately perpendicular to a next lower converging cone inner surface or a projection of the next lower converging cone inner surface, the bulk material or liquid transiting the chute follows a path formed by the converging cone inner surface and the diverging cone outer surface, and substantially slows down or stops forward motion from one cone to the next cone, changes direction, and continues down the chute; at least one outboard converging cone truncated on top and bottom, and individually corresponding to at least one of the first set of converging cones, the at least one outboard converging cone having a larger diameter than, and coaxial with, the at least one of the first set of converging cones to reduce the freefall distance of the bulk material or liquid when the at least one of the first set of converging cones overflows; and a support structure for vertically aligning and securing in place the diverging cones and the first and second sets of converging cones, the structure peripherally open to the container.

In a fourth aspect, the present invention is directed to a chute for conveying bulk material or liquid from a higher location to a lower location, the chute comprising: a plurality of converging cones truncated with openings at top and bottom, each of the converging cones having an inner surface, an apex pointing downwards, and a first apex angle; a plurality of diverging cones, each diverging cone corresponding to one of the plurality of converging cones, the diverging cones having an outer surface, an apex pointing upwards, and a second apex angle; the converging and diverging cones vertically aligned and arranged in alternating downwards and upwards directions with one cone below the next, such that a projection of the converging cone inner surface plane intersects with and is approximately perpendicular to a next lower diverging cone outer surface or a projection of the next lower diverging cone outer surface, and a projection of the diverging cone outer surface plane intersects with and is approximately perpendicular to a next lower converging cone inner surface or a projection of the next lower converging cone inner surface, the bulk material or liquid transiting the chute follows a path formed by the converging cone inner surface and the diverging cone outer surface, and has portions that substantially slow down, stop forward motion, or momentarily flow or move upwards while falling from one cone to the next cone, said bulk material or liquid changes direction, and continues down said chute; a support structure for vertically aligning and securing in place the converging cones and the diverging cones, the structure peripherally open to the container; and a lifter for raising and lowering the chute.

In a fifth aspect, the present invention is directed to a system for conveying material or liquid from a higher location to a lower location, the system comprising: a plurality of chutes, each including: a plurality of converging cones truncated with openings at top and bottom, each of the converging cones having an inner surface, an apex pointing downwards, and a first apex angle; a plurality of diverging cones, each diverging cone corresponding to one of the plurality of converging cones, the diverging cones having an outer surface, an apex pointing upwards, and a second apex angle; the converging and diverging cones vertically aligned and arranged in alternating downwards and upwards directions with one cone below the next, such that a projection of the converging cone inner surface plane intersects with and is approximately perpendicular to a next lower diverging cone outer surface or a projection of the next lower diverging cone outer surface, and a projection of the diverging cone outer surface plane intersects with and is approximately perpendicular to a next lower converging cone inner surface or a projection of the next lower converging cone inner surface, the material or liquid transiting the chute follows a path formed by the converging cone inner surface and the diverging cone outer surface, and substantially slows down or stops forward motion when contacting each subsequent cone, changes direction, and continues down the chute; and a support structure for each of the chutes, vertically aligning and securing in place the converging cones and the diverging cones; wherein the chutes are spaced apart within a floor of a large container.

In a sixth aspect, the present invention is directed to a chute for conveying bulk material from a higher location to a lower location, the chute comprising: a first set of flat plates, each having an inner surface, and angled in a first direction to direct the bulk material; a second set of flat plates, each corresponding to one of the first set of flat plates, the second set of flat plates angled in a second direction opposite the first direction to direct the bulk material in an opposite direction from the first direction; the flat plates aligned and arranged in alternating first and second directions with one plate below the next, such that a projection of a flat plate in the first direction intersects with and is approximately perpendicular to a next lower flat plate in the second direction, and a projection of the flat plate in the second direction intersects with and is approximately perpendicular to a next lower flat plate in the first direction, the bulk material transiting the chute follows a path formed by the first and second set of flat plates, and substantially slows down or stops forward motion when contacting each subsequent plate, changes direction, and continues down the chute; and a support structure for vertically aligning and securing in place the first and second sets of plates, the structure partially open to the container.

In a seventh aspect, the present invention is directed to a combination of two cones at the discharge point of a bin, the combination comprising: a diverging cone having an outer surface, an apex pointing upwards, and a first apex angle; a converging cone truncated with openings at top and bottom, the converging cone having an inner surface, an apex pointing downwards, and a second apex angle; the converging and diverging cone vertically aligned with one cone below the next, such that a projection of one cone's surface plane is approximately perpendicular to a lower cone's surface or a projection of the lower cone's surface, such that bulk material transiting the combination follows a path formed by the converging cone inner surface and the diverging cone outer surface, and substantially slows down or stops forward motion when contacting the lower cone, changes direction, and continues down the chute; and a support structure for vertically aligning and securing in place the converging cone and the diverging cone, the structure peripherally open to a container.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself however, both as to organization and method of operation, may best be understood by reference to the detailed description which follows taken in conjunction with the accompanying drawings in which:

FIG. 1A depicts the preferred embodiment of the switchback chute of the present invention.

FIG. 1B depicts a cross-sectional view of the switchback chute mounted inside a storage bin and supported by cables.

FIG. 2A depicts a test bin with sixteen identified sampling locations.

FIG. 2B is a graphical representation of the fine particle (fines) percent data gathered from samples drawn from the center of an outlet tube of a funnel flow bin with no chute.

FIG. 2C depicts a graphical representation of the results for an identical bin of FIG. 2B with a switchback chute installed.

FIG. 3A is a top-down view of a support structure.

FIG. 3B depicts a side cross-sectional view of the support structure of FIG. 3A that utilizes one main central support shaft for the cones.

FIG. 4 depicts a cross-section of the switchback chute design of the present invention employing top reverse deflector cones for each converging cone and a tubular heating and/or cooling coil wrapped around the exterior of the lower cone.

FIG. 5A depicts a sectional view of the switchback chute configured with an outboard auxiliary converging cone associated with a converging cone.

FIG. 5B depicts a sectional view of the switchback chute with multiple outboard cones for at least some converging cones.

FIG. 6 depicts a sectional view of a lower, shoot-the-gap truncated, converting cone associated with a diverging and converging cone combination.

FIG. 7A depicts a dust containment skirt for the switchback chute of the present invention.

FIG. 7B depicts a frontal view and top view of overlapping strips of a dust containment skirt.

FIG. 7C depicts the dust containment skirt of FIG. 7A wrapped around a converging cone and hanging down towards a next lower converging cone.

FIG. 8 depicts an exemplary embodiment of the present invention for filling a portable container or sack using the switchback chute.

FIG. 9 depicts the switchback chute employed in a sack container, with a storage and containment column for the chute, a mechanism for inserting and extracting the chute from the container, sensor and sensor wires, and an input for material.

FIG. 10 depicts a hybrid arrangement of an enclosed portion of a switchback chute for delivering material from an overhead conveyor or supply into a small surge container.

FIG. 11A depicts a top-down view of a large diameter silo with multiple switchback chutes employed therein.

FIG. 11B depicts a frontal sectional view of a large diameter silo with multiple switchback chutes employed therein.

12A depicts a top view of a large barge cargo area with multiple switchback chutes.

FIG. 12B depicts a side view of the barge of FIG. 12A.

FIG. 13 depicts bottom support posts and tube structures for temporary or permanent installation of chutes in a cargo area, used to keep the upper portion of a cargo area unobstructed by supporting structures.

FIG. 14A depicts a top view of portable switchback chute bases with support legs or support structure attached.

FIG. 14B depicts a front view of portable switchback chute bases with support legs or support structure attached.

FIG. 15 depicts a cross-sectional side view of a transition switchback chute, where the switchback chute surfaces are flat rather than conical.

FIG. 16 depicts a single combination of a converging cone and diverging cone at the point of discharge of a bin or container.

### DESCRIPTION OF THE PREFERRED EMBODIMENT(S)

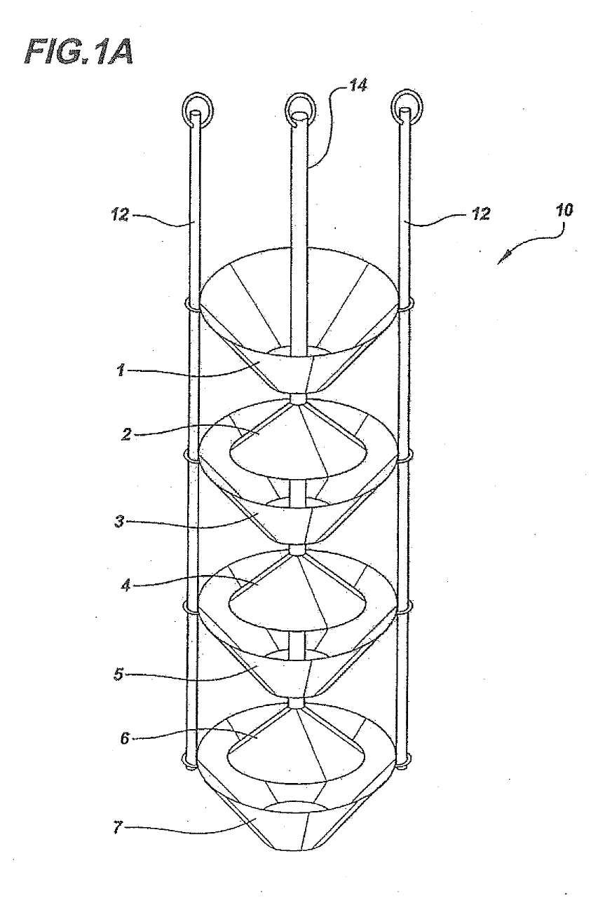

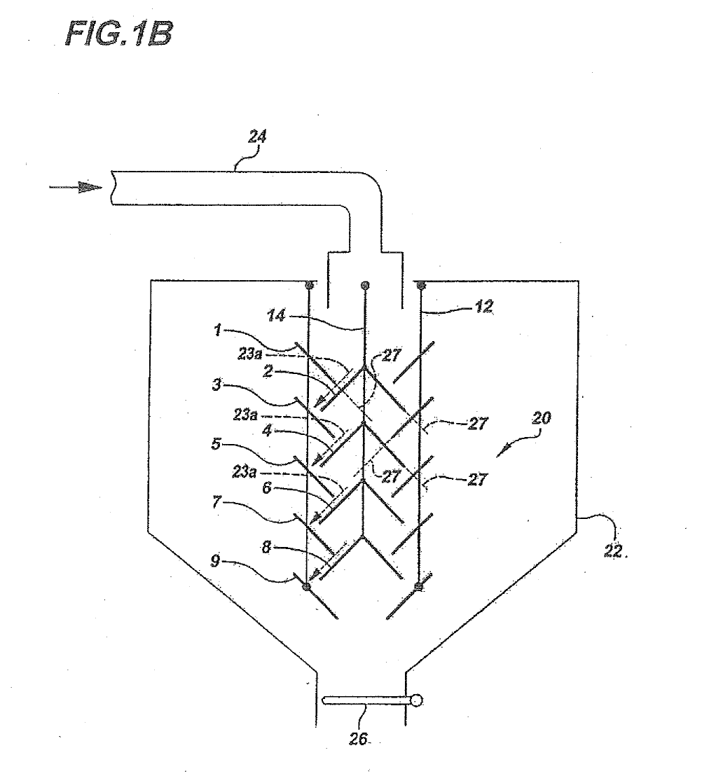

In describing the preferred embodiment of the present invention, reference will be made herein to FIGS. 1-16 of the drawings in which like numerals refer to like features of the invention.

The unique design of the switchback chute inherently causes it to maintain tight control of the bulk material throughout the length of the chute and slows its vertical descent to such a low level that it minimizes various types of segregation problems that may occur with conventional chute systems.

The essential properties of the switchback chute of the present invention are that it includes a plurality of surfaces that are arranged vertically, one substantially below the next, and directed such that some or all of the adjacent surfaces cause the bulk material transiting the chute to frequently stop its forward motion momentarily, and then change direction or switch back. The directing surfaces may be flat or curved or partially conical in shape, but preferably they are cone shaped, with a combination of truncated cones and complete cones, or all truncated cones.

In a preferred embodiment, the switchback chute includes a series of vertically aligned hollow, truncated, and complete cones arranged in alternating downwards and upwards directions. FIG. 1A depicts a first embodiment of the switchback chute 10 of the present invention. As shown in FIG. 1A, odd numbered cones 1, 3, 5, 7 are truncated cones, open at top and bottom, having their narrow end or apex pointing downward. These cones will be referred to as converging cones, because they tend to make the falling material converge on itself. The even numbered cones 2, 4, 6 are not truncated at the apex in this embodiment as are the odd numbered cones, although the present invention does not preclude such truncation in a separate embodiment. In this example, the even numbered cones have their pointed tip upwards facing, to diverge the material flowing through the chute. These cones are referred to as diverging cones. The cones are held in place by a frame support having support members 12 on the outer periphery of each converging cone and through the center 14 of the diverging cones. The support structure may be tubes, poles, or cables, and the like, capable of supporting the forces of falling bulk material.

When selecting the material of the cones, angle of repose of the bulk material, coefficient of friction with the chute's surfaces, its abrasiveness and corrosive properties are all taken into consideration.

FIG. 1B depicts a cross-sectional view of the switchback chute 20 as perceived inside a bin 22. The chute is located in the center of bin 22, although other locations are as readily feasible. In the preferred embodiment, an input feed 24 is situated above the chute to direct material to the chute's center. A slide gate valve 26 is shown, but the invention is independent of the bin features, and importantly requires little or no modification to the bin, although mounting point supports may be employed. Preferably, the chute extends from the top or input end of the bin to just above the bottom or discharge port of the bin.

The order of diverging and converging cones may be reversed from those shown in FIGS. 1A and 1B. The chute may start with either a converging or diverging cone at the top depending on the method of supply of bulk materials to the chute.

As shown in FIG. 1B, the cones are preferably situated such that a projection 27 of the converging cone inner surface plane intersects with and is approximately perpendicular to a next lower diverging cone outer surface or a projection of the next lower diverging cone outer surface, and a projection of the diverging cone outer surface plane intersects with and is approximately perpendicular to a next lower converging cone inner surface or a projection of the next lower converging cone inner surface. Dashed-arrows 28 indicate the flow of material. The material will flow from the plane of one cone surface to the next adjacent cone surface, where it will intersect the surface preferably at or about 90°. By intersecting at or near this angle, the material flow momentarily stops its forward movement, and then changes or alters direction such that the net downward vertical velocity is substantially slowed. At least some of the particles will tend to bounce back or rebound in a direction opposite the original path, thereby sustaining a negative velocity for a brief period of time. If desired for a particular particle flow, the angle of intersection may be changed from the perpendicular. Additionally, the apex or point of a lower diverging cone may be located within the bottom hole of a corresponding upper, truncated converging cone, as depicted in FIG. 1B. The size, spacing, apex angles, and material of each component are selected to accommodate a particular bulk material or liquid or classes thereof, such that segregation is minimized, and desired overflow and flow rate are achieved.

In the depicted embodiment of FIGS. 1A and 1B, a material, generally in the form of a powder or granular stream, enters cone 1 at the top of the assembly and converges and consolidates as it slides down along the inside concave surface of the cone. As the powder exits the downward pointing, truncated cone 1 it travels unsupported (freefalls) a short distance as indicated by arrow 28a, substantially maintaining the same path, and then contacts the oppositely inclined outer wall of cone 2, a diverging cone. Due to the momentum of the material exiting each cone, the material will tend to continue roughly along the same path for a short distance from, the exit of the upper cone to the surface of the lower cone. If the distance to the next surface is short enough the trajectory is relatively straight. Thus, from cone to cone, the material follows at a trajectory in the direction of the upper cone's conical shape. The material continues to traverse from cone to cone while abruptly stopping its forward motion and changing direction at each cone interface.

As the material particles impinge on the oppositely sloping wall of the lower cone they momentarily come to an abrupt stop or significantly slow down their forward motion and then change their current direction, briefly halting forward movement. After the material or powder stream changes or switches direction it spreads out as it travels down over the convex surface of the first diverging cone, cone 2. The point of direction change is referred to as the switchback area. Preferably, the new direction that the lower cone generates is roughly 90°, perpendicular from the original direction. The stopping and slowing motion, bounce back, the changing of direction, and the converging and diverging spreading actions, are processes that repeat as the material or powder stream switches back-and-forth down the chain of cones in the chute.

The spreading and re-consolidating or re-combining actions occurring on and along the chute's cone surfaces serves to provide a beneficial remixing of small and large particles or otherwise different particles. Other forms of remixing actions occur at the switchback areas. The remixing tends to eliminate segregation in the material as it traverses the switchback chute to the bottom of the bin.

Sifting segregation occurs when bulk materials slide down a chute. The smaller particles sift to the bottom of the material stream while the larger particles are left on top. The switchback chute minimizes this type of segregation because the sliding sections are kept very short and also because the switchback chute counters this type of segregation, and other types of segregation, with a variety of remixing self-correcting actions.

Some examples of segregation reversing actions initiated by the switchback chute design of the present invention occur in the vicinity of the switchback areas. At impact points, the upper layer of the stream of material, which may have more heavy particles and fewer fine particles due to sifting generated segregation, slides down along each cone wall and ends up under the previous bottom layer, thus making the fine particle rich bottom layer flip to become the top layer.

Furthermore, where the stream of particles impacts a cone wall, some of the upper portion of the stream of particles traverse up the cone wall, acquire an upward or negative velocity with respect to their initial downward direction, and roll around to form a donut-shaped ring. This rollback action is an additional mechanism of slowing and remixing the stream of particles.

It also appears that the stream of material is partially dispersed by impacting the cone walls at the switchback points and then re-mixed as it quickly recombines.

The above described actions of spreading and recombining on the upper surfaces of the cones, the flipping and rolling actions, and the impact-caused spreading and rejoining action at the switchback points continually repeat as the powder flows down the chain of cones. These repeating, multiple types of remixing actions of the switchback chute compensate for minor segregation that may occur in the master mixer/blender, in the system that conveys the material to the chute, and for sifting and sliding segregation and other types of segregation that may occur within the chute.

The remixing actions of the switchback chute also correct for impact-caused fluidization segregation occurring within the chute, and for aeration segregation, which is associated with free-falling material in the free-fall sections of the chute.

The mixing action of the switchback chute has been visually confirmed by poring a container of white powder of lower bulk density and a container of black powder containing both very fine and large particles, at the same time into the top of the switchback chute. A visual cross sectional examination of the resulting pile under the discharge end of the chute demonstrated that the powders were significantly mixed and lacked any visible trace of segregation.

In the depicted embodiment of FIG. 1A, the bottom cone is preferably a converging cone. Typically, as the first material begins discharging from the bottom cone a conically shaped pile starts to form on the bottom of the bin. The angle of the sides of the pile is determined by the angle-of-repose for the particular material. As the bin fill level rises up to the bottom of the lowest converging cone and blocks it, that cone begins to fill up. When the bottom converging cone is completely full, material arriving from above starts overflowing into the bin. The material then falls a short distance and contacts the pile below. The overflow condition will continue until the pile reaches and blocks the outlet of the next converging cone above. In succession each converging cone just above a buried cone will discharge material into the bin until that cone is blocked. The unaffected cones above will continue with their switchback letdown operation until they, in turn, fill and overflow. These actions continue until the bin is ultimately filled to the desired level.

Another beneficial action of the switchback chute is that the angle at which the particles meet the building pile varies as the filling process progresses. When a converging cone becomes blocked at its bottom or discharge end due to the rising top of the pile it fills up and begins to overflow, the material drops a short distance to the pile and strikes the pile in a predominantly vertical direction. As the pile continues to build the distance of the drop becomes less, and the flowing stream slowly transitions from a vertical drop to a shallow incline as the pile works up higher to the more flat portion of the trajectory curve of the material exiting at the top of the cone.

This process of transitioning between short slow speed dropping and slow speed sliding for each cone set minimizes segregation that may occur after the material leaves the confines of the chute, and helps ensure that no one type of segregation is permitted to predominate. Any various localized minor areas of segregation will tend to balance each other out as natural blending occurs as the bin empties. Therefore, funnel flow bins and mass flow bins will have similar homogenization of the bulk material after filling, and at the exit of the bin throughout the emptying process.

In addition to the inherent re-mixing actions described above there are a number of other beneficial features of the switchback chute that correct or compensate for non-uniform flow that may be caused by irregularities in the in-feed supply of the bulk material, irregularities within the bulk material, or physical irregularities in the chute itself.

For example, if the flow of bulk material into the chute entrance is not always aligned on the center of the chute, or if there are any unbalances of flow created within the chute, then the flow on one area of a cone will be heavier and deeper. As one area of a cone experiences a thicker or heavier flow, the stream will spread out along the cone's upper surface, and thin due to the force of gravity until a more uniform thickness of material is achieved. Also the stream will tend to pass around a jam, blockage, or concentration wherever one is encountered.

If flow is not uniformly distributed around the inside of the chute, the bin will begin to fill faster on the heavy flow side. The heavy flow side of the lowest operating cone will be the first side blocked by the rising pile. The design of the switchback chute then causes the flow to shift around to the still open area(s) of the cone until an even bin fill level is achieved and the final open area at the cone's discharge fills, at which time the apex of the building pile will begin moving upwards to block the discharge of the converging cone above. Thus, the bin will fill substantially evenly all around the chute.

These multiple flow directed self-correcting and self-leveling features and the various remixing actions, described above, provided by the switchback design, helps ensure that all the material receives substantially similar treatment and that the bin will fill with substantially the same bulk density and even distribution of fine and heavy or otherwise dissimilar particles throughout.

If a chute is not able to completely overcome all segregation, and if a specific pattern of modest segregation of vertical bands or horizontal bands exists in the bin, then the combination of the switchback chute with a particular type of bin may compensate for this segregation. As known in the art, mass-flow style bins and funnel-flow bins have different patterns of flow during discharge that may correct for certain types of segregation.

A feature of the switchback chute design is that it may be adjusted to switch a bin that is a funnel-flow bin into a substantially mass flow-bin. If the lower cone set is moved closer to the bottom of the bin, the funnel disappears and the surface of the pile descends in a substantially flat and horizontal state. The reverse is also expected. A mass-flow bin may be converted to funnel-flow. An observed flattop, however, is not conclusive that a bin is in mass flow throughout all areas of the bin.

The design of the switchback chute, which slows the material flow significantly imparting only very low shear forces to the material, makes it suitable for many fragile or friable materials that are prone to damage in conventional chutes.

Another feature of the switchback chute is that it may be permanently installed in the bin and remain submerged in the bulk material without interfering with uniform container filling and emptying. Used in permanent installation, the switchback chute is completely static, with no required manipulation of the chute.

Observations suggest that the switchback chute enhances orderly bin emptying of funnel flow bins by minimizing undesirable tendencies for forming cavities or rat-holes, flooding, and fluidization phenomena sometimes associated with bin discharge. The switchback chute tends to prevent the funnel apex from reaching the bottom discharge opening of the bin. It shortens the funnel by effectively clipping off the bottom portion, thereby isolating the material that is discharging from the bin from the effects of funnel collapse surges, aeration, and fluidization of the bulk material occurring in the funnel area above. Thus, equilibrium can be restored as these disruptions are allowed to settle out in isolation without disturbing the discharge from the bin.

Furthermore, the cones of the present design work to breakup arching tendencies by providing a lower friction surface to slide on as compared with the friction of the material to itself.

In addition, the present design allows the bottom section of the chute to retard rapid exchanges of material at the discharge area of the bin with air from outside the bin that would otherwise initiate undesirable and extremely rapid discharge of the bins' material, known as flooding.

Because of the features mentioned above, the switchback chute promotes bin discharge that is smooth, without surges, excessively aerated or fluidized, and substantially free of other undesirable fluctuations and complications.

The switchback chute design contributes to reducing dusting that is associated with free-falling material because the velocity of the material through the air is always maintained at very low levels. The switchback chute greatly reduces impact dusting (fluidization) because the minimal velocity of the bulk material ensures that the impact forces of the material are very low against the chute surfaces, the material itself, and with the forming pile of material.

The switchback design is very tolerant of variation in flow rates of the bulk material entering the chute. The switchback chute works well with light flow, heavy flow, variable flow, and even pulsing flow.

The switchback chute is designed for extraction or lifting out of a full container if desired, and if done slowly the bulk powder in the cones will empty substantially in place in the bin with very little free-fall or dusting, and no noticeable segregation. This feature can be used, for example, to fill portable containers, drums or super-sacks, such as Flexible Intermediate Bulk Containers or FIBC's, when the chute will not be transported with the container. Other examples where chute removal is desirable are for filling barges, trucks, and rail cars.

Preferably, the switchback chute size is compact and small in diameter when compared to the cross section of the container so that its presence reduces the bins' holding capacity only a small amount.

The design of the chute allows for the use of very lightweight materials in the construction of the cones and their internal support members. Each cone sees only a small portion of the weight or load of the material above because the cone above shields it. The vertical loading on each cone due to the weight of the material above is spread out or distributed along the cones such that each cone experiences only a light downward load. Also the bulk material fills both the inside and outside of the larger converging cones so that they are somewhat supported by the bulk material that they are submerged in.

In a test model switchback chute, the bins were five feet square, about ten feet tall including an inwardly inclined discharge section. The chute assembly weighed only 35 pounds, which amounts to about 3.5 pounds per foot. Depending upon material selection, it may be made even lighter if necessary or desired. The cones are preferably made from ⅛″ thick plastic sheets of DELRIN™ or 1/16″ thick sheets of UHMW P.E. plastic, or other suitable material, such as stainless steel and the like. Using these materials, no deformation of the light cones was observed.

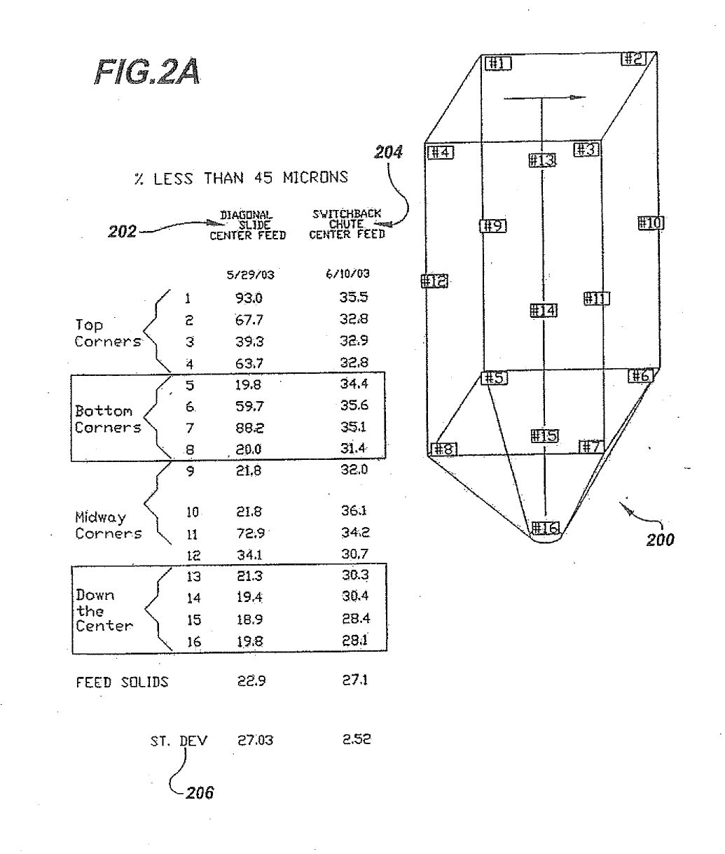

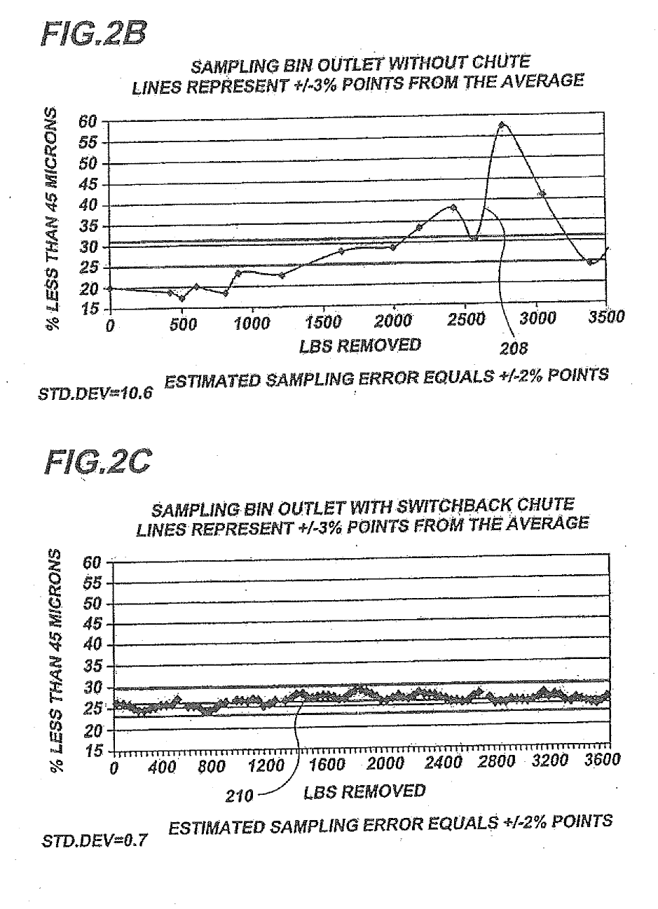

FIG. 2A depicts a test bin 200 with sixteen identified sampling locations. The accompanying data table shows the percentage of fine particles for each location. Data from a slide chute bin 202 is compared to data from a switchback chute 204. The slide chute extended diagonally from the top center to about the middle of the bin and discharged towards a corner. The data shows that throughout the sixteen locations, the switchback chute generated a uniform distribution of fine particles with little deviation. In contrast, the slide chute had a wide range of fine particle percentage dependent upon location. The relative variability of the percent of fine particles is indicated by the standard deviation 206.

FIG. 2B is a graphical representation of the fine particle (fines) percent data gathered from samples drawn from the center of an outlet tube of a funnel flow bin with no chute. As the material is removed and measured, the percentage of fines less than 45 microns is recorded 208. This data indicates that a significant amount of segregation is realized when no chute is used. FIG. 2C depicts a graphical representation of an identical bin with a switchback chute installed 210. The percentage of fines is virtually constant, having a standard deviation of less than one.

The switchback chute design also considers friction as an important anti-segregation attribute. The lowest possible friction of the chute surface to the bulk material allows the bulk particulate material to incur minimal sliding separation as it traverses the chute. It is desirable to have bulk materials enter the chute together and exit the chute together without segregation. It is also desirable to have the cones empty out naturally, without applying mechanical action as the bin empties. Thus, chute cone materials are specified to have a very low coefficient of friction to the material being conveyed.

The switchback chute employs the principle that frequent stopping and re-starting at short intervals interrupts the rapid increase in velocity and kinetic energy of particles that occurs if bodies are allowed to freefall long distances without interruption. In this way the vertical and horizontal components of velocity of the material within the switchback chute, and therefore its kinetic energy, are kept low. This ensures that the terminal velocity and kinetic energy of the material as it exits the switchback chute and contacts the pile are also very low.

In order to minimize sliding associated segregation, each sliding section of the chute is designed to be short. The spacing between the cones is kept short so that segregation related to material freefalling through the air is minimized. By alternating sliding and freefall sections and keeping them short, newly created segregation is limited. Because the duration and length of each section of the chute where segregation might occur is kept short, the numerous and almost immediate corrective features of the switchback chute easily erase segregation generated by and within the chute.

Switchback Chute Construction

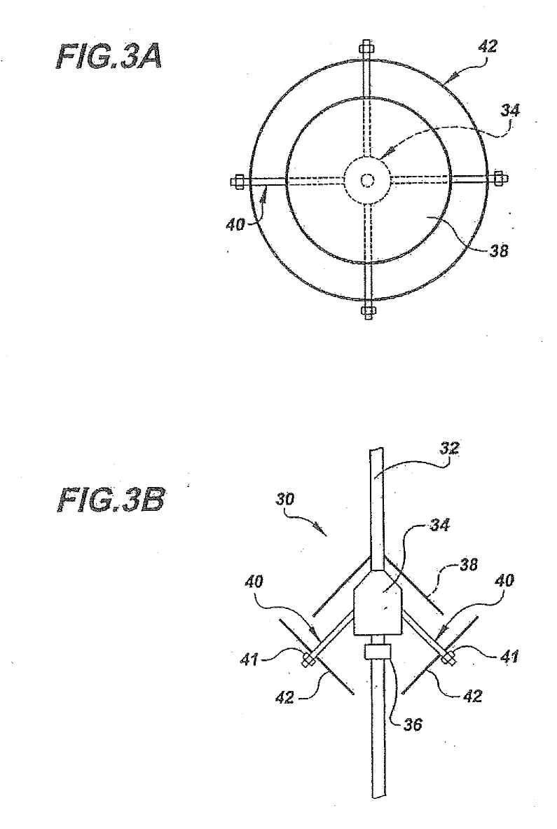

As previously stated, the cones of the switchback chute may be fabricated, for example, from sheets of UHMW P.E. or DELRIN™. These materials are slippery, wear resistant, lightweight, and easy to form. The chute cones may be suspended from above and/or supported from below. The suspensions or supports are preferably constructed from suitable materials such as threaded rods, rods, tubes, straps, cables, ropes, chains, and the like. FIG. 3 depicts a side view and a top-down view of a support structure 30 for the cones that utilizes one main central support shaft 32. As shown in FIG. 3B, the support shaft 32 holds a support hub 34, held in place by a locking collar 36. The top of the support hub 34 is used for mounting a diverging cone 38. Rods 40 extend from the support hub, preferably threaded at each end to attach to and support a converging, truncated cone 42 with a locking device 41, such as a nut, A support hub is situated about the shaft for each pair of diverging and converging cones. Instead of a locking collar, a spacer or bushing tubes may be used to separate each support hub. FIG. 3A is the top-down view of the support structure.

The size of the cones of a switchback chute, the spacing and clearance between them, the size of their top and bottom openings, and their apex angular slope, are dictated by the characteristics and free flow properties of the material that will be conveyed, and by the volume or weight per unit time or flow rate that is desired.

Top Reverse Deflector Cones

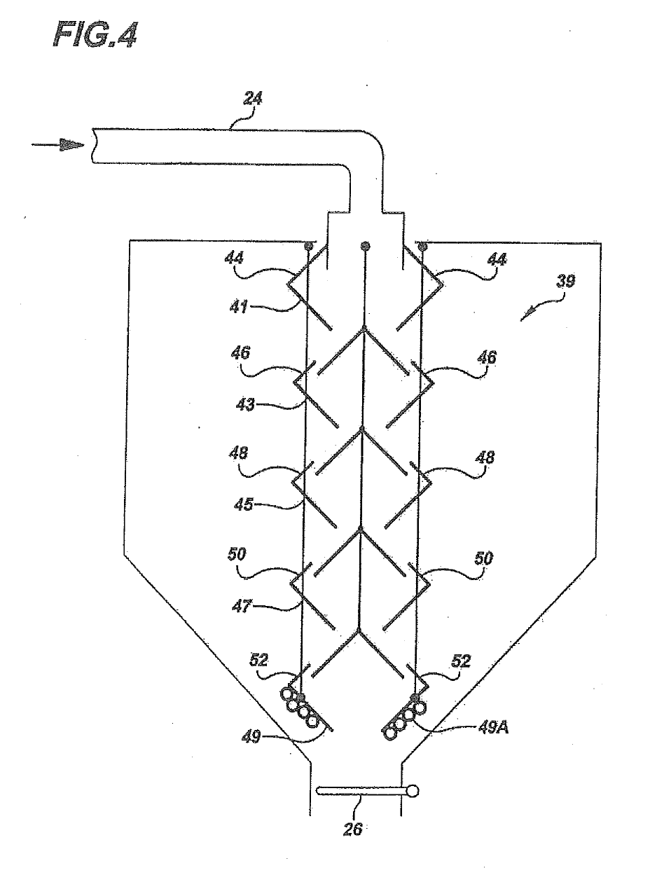

A second set of truncated cone segments is introduced in the present invention on the top of one or more of the converging cones, preferably on at least the top most cone, in order to contain any overflow due to surges of material, particularly when the flow of material to the chute is erratic and non-uniform, or the material is loaded heavier on one side. These truncated cones are referred to as top reverse deflector cones. FIG. 4 depicts a cross-section of the switchback chute design of the present invention employing top reverse reflector cones for each converging cone. Their use is particularly beneficial for containing dust and premature base material overflow of the converging cones when conveying material with very fine, light, fluffy, or dusty components, and for highly aerated materials, which tend to have flow properties similar to fluids rather than solids. Switchback chute 39 is shown with converging cones 41, 43, 45, 47 and 49. Top reverse deflector cones 44, 46, 48, 50 and 52 are truncated, diverging cone segments situated at the top of each converging cone.

For certain materials conveyed without using the deflector cones, the outside diameter of the top of the converging cones must be larger in order to contain the undesired overflow. A too large outside diameter diminishes or prohibits the proper overflow process earlier described. If the angle between the discharge edge of a higher converging cone to the upper outside edge of the next lower converging cone is too shallow, or less than the angle of repose of the material, the materials will not properly overflow, but instead will backup or rise up to block the output end of the upper cone and thereby shutoff flow. It is beneficial for the uppermost converging cone to be completely enclosed by a shroud or full reverse deflector cone as depicted in FIGS. 4, 5 and 15, connecting the cone to the input device in order to contain material if it is delivered to the chute at high velocity, or which is highly aerated or fluidized.

Outboard Cones

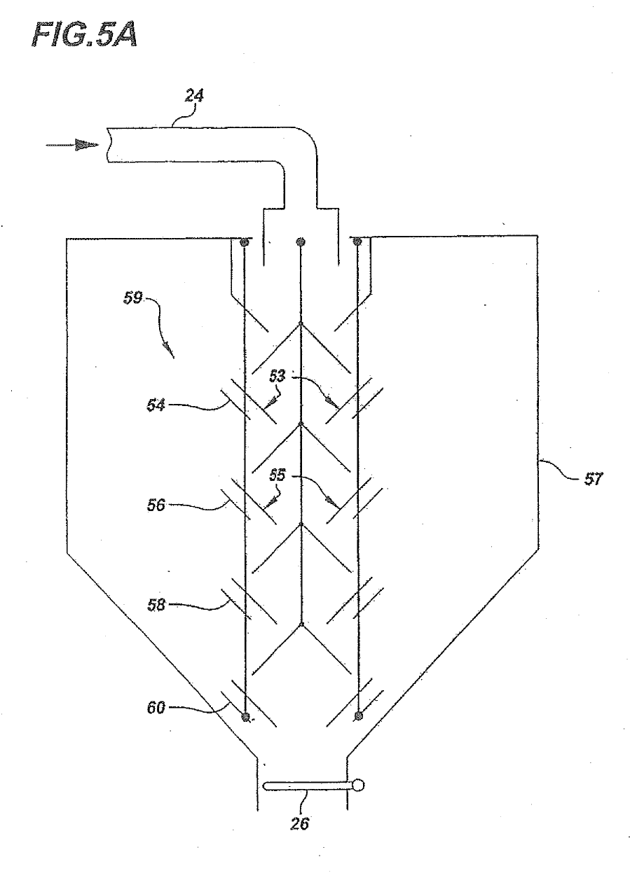

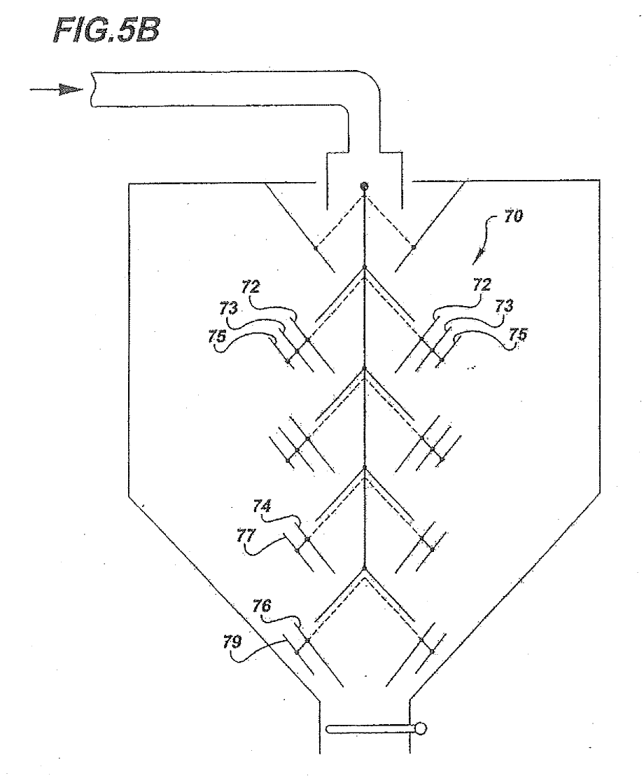

Outboard converging cones as shown in FIGS. 5A and 5B may be employed. The outboard cones 54, 56, and 58 are associated with converging cones 51, 53, 55, respectively, and are designed to reduce the freefall distance when the converging cones overflow. A longer freefall distance contributes to greater segregation. The outboard cones may be employed when conveying materials that are extremely prone to separation, dusting, and/or damage. As shown, the outboard cones are converging, truncated cones situated about the outside of each inner converging cone. FIG. 5A depicts a sectional view of the switchback chute in a storage bin 57 with outboard cones 54, 56, 58, and 60. In this embodiment, the first converging cone 59 does not employ the optional outboard cone since it is enclosed by a shroud and thus will not overflow.

FIG. 5B depicts a sectional view of the switchback chute 70 with multiple outboard cones for at least some converging cones. Converging cone 72 works in tandem with two outboard cones 73, 75. The outboard cones are designed one larger than the other, surrounding the outside of the associated converging cone, and coaxial with the converging cone. In the example depicted by FIG. 5B, some converging cones 74, 76 have only one associated outboard cone 77, 79 respectively. The combination of outboard cones to converging cones is optional, and dependent upon a number of factors, including the bulk material, the cones sizes, and the material flow rate, to name a few. Any configuration of outboard cones to converging cones, including multiple outboard cones for a single converging cone may be employed to slow down and reduce freefall distances of the overflow material.

Shoot-the-Gap Converging Cones

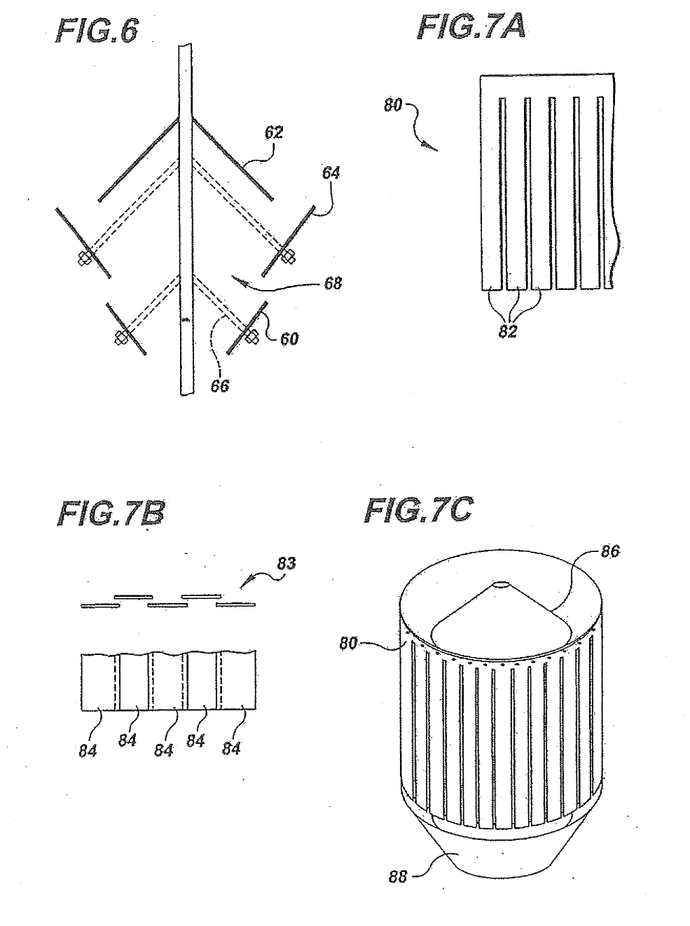

Segmented converging cones may be employed to shorten the vertical free fall of material when natural cone overflow occurs. The truncated, converging cones are referred to as shoot-the-gap converging cones. FIG. 6 depicts a lower, shoot-the-gap truncated, converting cone 60 associated with a diverging 62 and converging cone 64 combination. In a similar fashion to the initial converging cone 64, the lower shoot-the-gap converging cone 60 is also supported by support rods 66. During non-overflow periods of operation the trajectory of the material will carry it across the gap 68 to the lower cone segment. When the material in the cone blocks up to the bottom of the gap it will overflow through the gap, dropping about half the distance it would fall if it had to overflow from the top of the upper cone segment. When the gap becomes blocked, the level of the material will rise to fill the top segment of the shoot-the-gap converging cone until it overflows. With this arrangement maximum free-fall distance is significantly shortened.

Dust Containment Skirts

Dust containment skirts 80 are depicted in FIG. 7. These skirts may be used for very dusty materials, when filling topless containers, and especially for outdoor use when wind will carry dust out of the chute. The skirts may be fabricated from sheeting slit into partial strips 82 as shown in FIG. 7A, or individual strips 84 of flexible material, such as rubber, or rigid strips hinged at the top. The strips 84 may overlap at the seams for improved dust tightness as shown in FIG. 7B. A top-down view of the ends of the overlapping strips is also depicted in FIG. 7B. In the exemplary embodiment, the skirt wraps around a diverging cone 86, and hangs down towards the adjacent converging cone 88 as shown in FIG. 7C. The strips 84 may spread out, enlarging the bottom opening when pushed by overflowing bulk material. They may also flex inward to allow material in the bin to empty through the chute if that is desired.

Flow enhancing aids, such as mechanical motion and/or vibration, may be applied to the chute assembly during filling and/or empting in order to counteract tendencies of some bulk materials to bridge/arch and/or rat-hole, and to enhance flow of materials that have other poor flow characteristics.

Filling Portable Containers

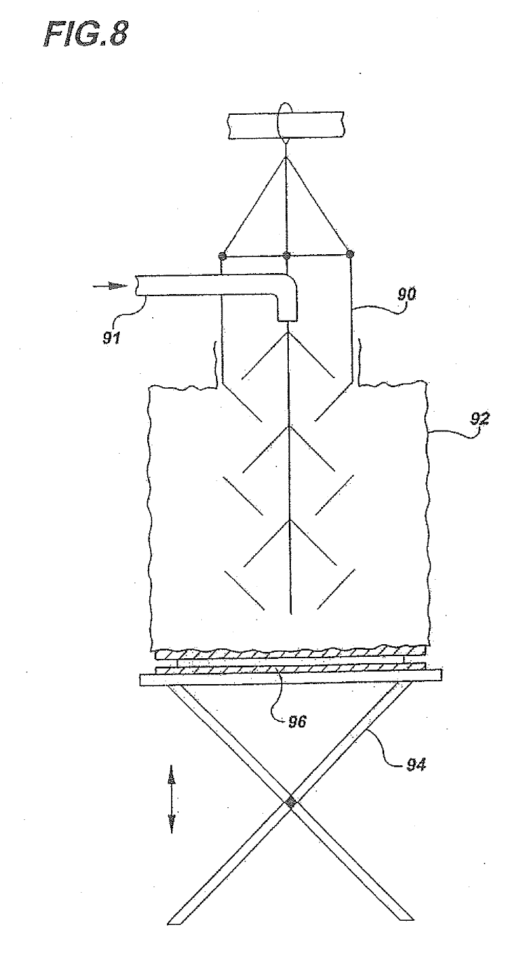

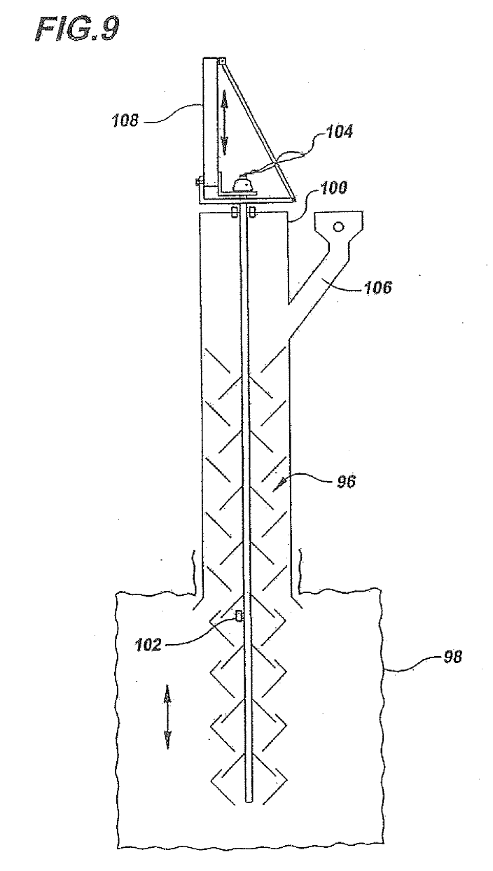

FIGS. 8 and 9 depict exemplary embodiments for filling portable containers using a switchback chute. In FIG. 8, the switchback chute 90 is employed within a portable sack 92, which may be mounted and filled while situated on a lift platform 94 and pallet 96, or other suitable lifting and lowering means such as a fork lift truck. The top portion of the chute and delivery means are enclosed or shrouded to connect to the container's opening, and the lower section is preferably open to the container. The chute is filled by a feed supply 91. FIG. 9 depicts the switchback chute 96 employed in a sack container 98, with an enclosing column or tube 100 for the chute, sensors and sensor wires 102, 104, and an input 106 for material. The FULL indication sensor 102 is located within the chute at the top of the sack container 98. The chute is shown mounted to a pistonless cylinder 108 used to position the chute into a portable container for filling and to then extract the chute when filling is complete, although other positioning schemes may be employed, and the design is not limited to any particular mounting scheme or positioning device.

The advantages inherent in the chute during emptying may also be used in temporary and portable containers. Since the chute is relatively inexpensive, it may be convenient and economically and operationally beneficial to have the switchback chutes stay in the portable hoppers, sacks, and other transport containers during filling, transportation, storage, and emptying.

Non-container Applications

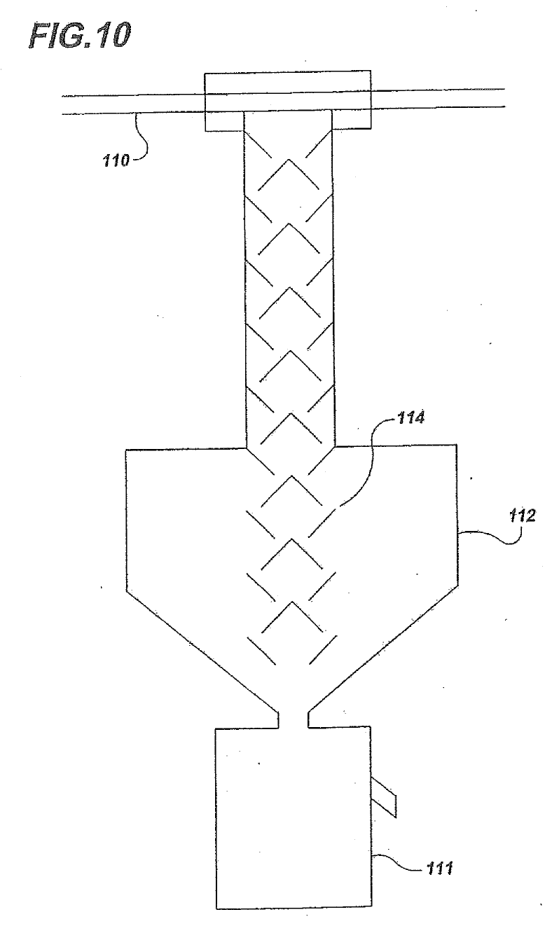

In non-container filling applications, for example letting down material from a higher floor to a lower floor in a processing plant, or from a transport conveyor down to a processing machine, the switchback chute may be incorporated within a tube. The tube may be made of flexible or rigid material and may be used as a structural support member. The tube or shroud will prevent dust and stray material release and prevent contaminants from entering the material stream. FIG. 10 depicts a hybrid arrangement of an enclosed portion of a switchback chute that delivers material from an overhead conveyor 110 or supply into a small intermediate surge container or accumulation bin 112 having a remaining section of the chute 114 open to allow for bin filling. As depicted in FIG. 10, a switchback chute may be employed in a material letdown function from an overhead supply to a storage bin, or directly to a processing operation or machine 111, thus eliminating the need for an intermediate storage bin.

A switchback chute enclosed within a rigid containment tube may store a modest amount of material above the processing machine. A switchback chute of large diameter and/or length can store a substantial amount of material, thus combining a storage or sump function along with its ability to let down material with minimum segregation.

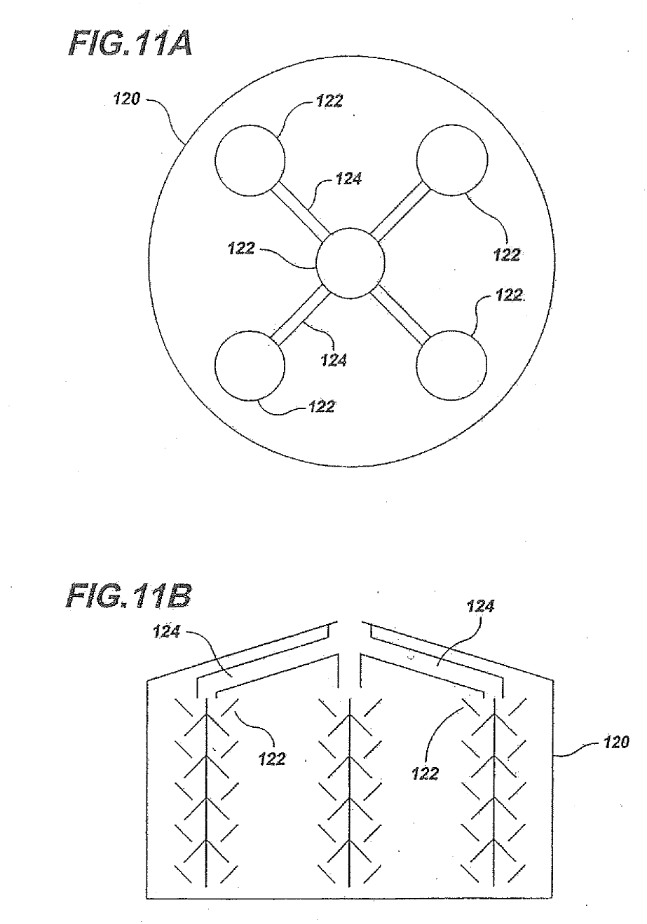

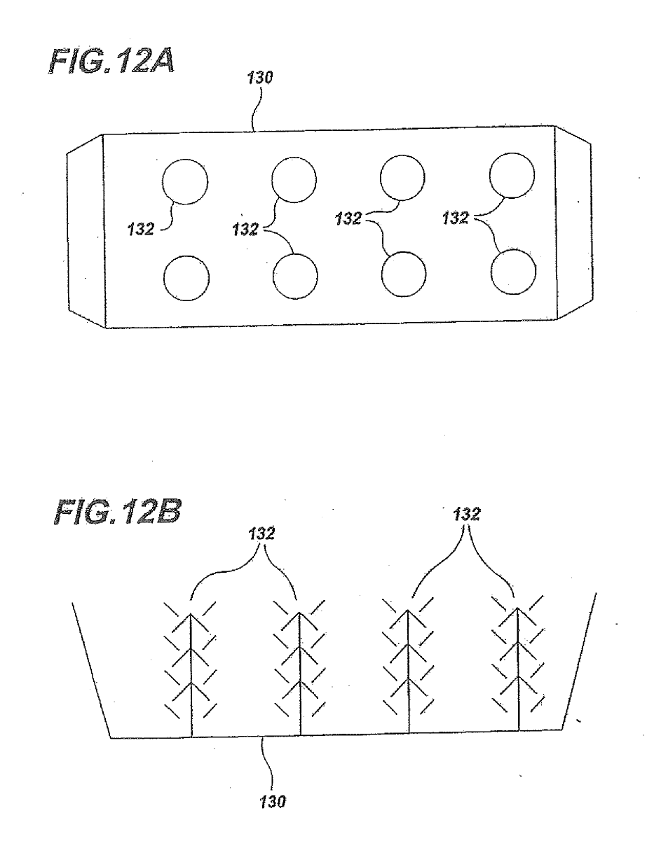

When it is desired to fill containers that have a very large cross section the angle-of-repose of the material discharged from a single switchback chute may prevent the pile from reaching the container's walls and thus the upper portion of the container will not fill completely, causing a loss of storage capacity. In such cases an arrangement of multiple parallel portable or permanently installed switchback chutes can be effective. Some such arrangements are shown in FIGS. 11 and 12. FIG. 11 depicts a large diameter silo 120 with multiple switchback chutes 122 employed therein receiving material from feeding tubes 124. The delivery tubes may be located inside or outside the bin.

Because the switchback chutes are minimally obtrusive they may be left in place in the container permanently if desired. In the case of large containers, such as barge cargo areas, which are normally emptied from above, rather than out the bottom the container, the multiple chutes may be only minimal obstacles to the extraction mechanism for the bulk material. FIG. 11A depicts the top view and FIG. 11B the side view of the switchback chutes having delivery tubes 124. FIG. 12A depicts a top view of a large barge cargo area 130 with multiple switchback chutes 132 in place. FIG. 12B depicts a side view of the barge of FIG. 12A.

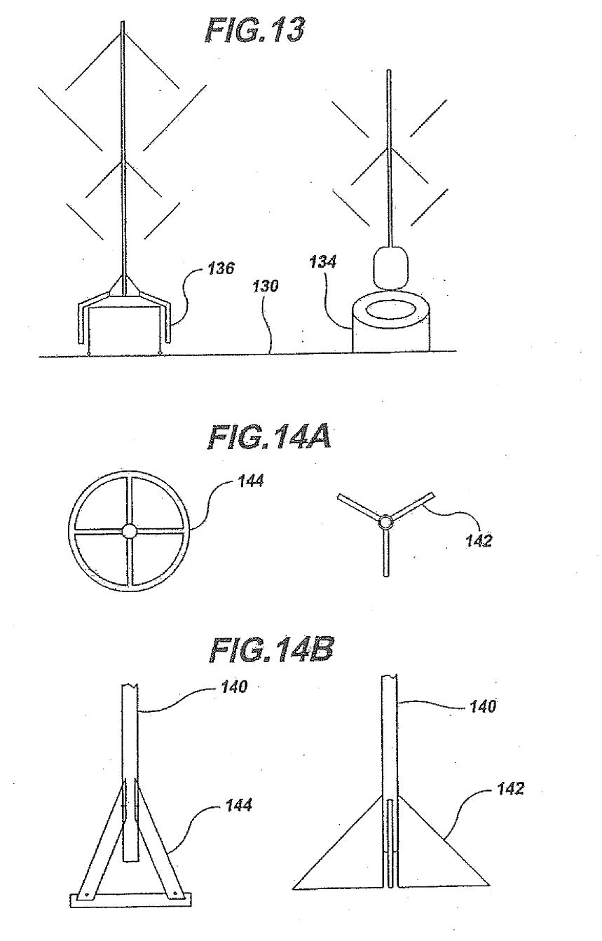

As shown in FIG. 13, bottom support posts or structures may be used when it is necessary to keep the chute's upper entrance areas unobstructed by supporting structures so that the bulk material delivery and extraction systems are not impeded in large containers, such as barge cargo areas. A mounting tube 134 is shown supporting a switchback chute, while a mounting post 136 is used to support another switchback chute. Any combination of mounting posts or tubes may be used as support mechanisms for the switchback chutes. In this exemplary embodiment, portable (removable) chutes are used to fill a transporter (cargo hold) with large cross sectional area(s). The small, short support members such as posts 136 or tubes 134 may be permanently affixed to the bottom floor of the container onto which the bottom of the chute's support shaft(s) or tube(s) are placed. Once the container is filled the chutes can be extracted if desired, or left in place. If removed, the chutes will not be obstacles when material is extracted from above.

In another exemplary embodiment, the portable chutes 140 may have their own support legs 142 or support structure 144 attached at their bottoms, as depicted in FIG. 14. The base of the chute with attached supports would set on the floor of the container before and during filling, and may be left in place if desired, or extracted, after the container is filled. Supports that are thin in the vertical direction will not significantly impede extraction of the chute.

The switchback chute is not restricted to inert operation. If desired the chute may be lifted clear of the pile during filling or letdown operations. Some examples where this procedure may be used are ship or barge filling, truck, and rail car filling, gentle concrete form filling, and slurry and liquid letdown. For these and other similar applications the switchback chute may be enclosed within a flexible dust shroud or a rigid outer containment tube. The shroud or containment tube may be incorporated as a structural member and provide a means of support for the cones. The strip skirts describe above may also be used.

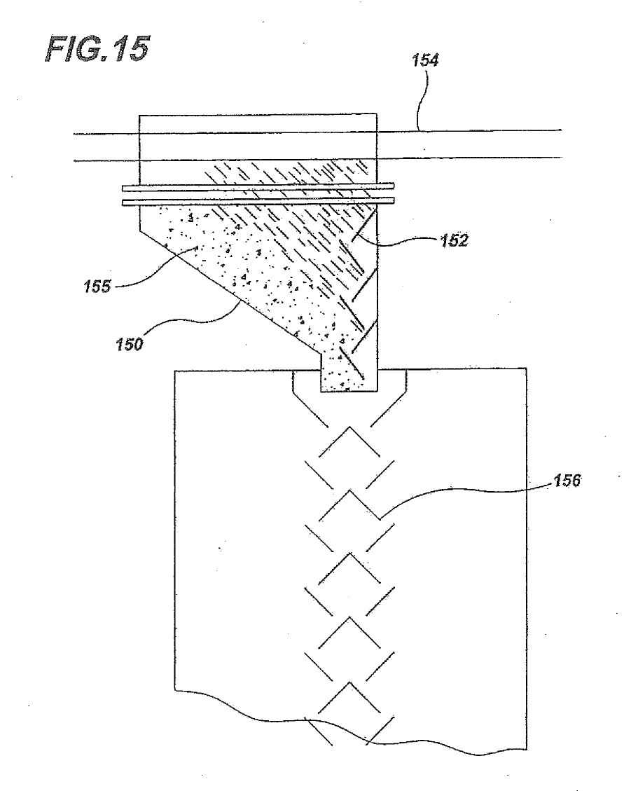

FIG. 15 depicts a cross-sectional side view of a transition switchback chute 150, where the switchback chute surfaces 152 are flat rather than conical. An overhead transport conveyor 154 connects to the transitional chute 150. The transitional chute collects material and dust 155 from the overhead conveyor and delivers it in a controlled fashion that helps eliminate segregation. The transition chute may feed a conventional switchback chute 156 as shown. Typically, the material exits along the bottom of the conveyor valve at high speed and some of which crashes into the adjacent wall of the transfer device. The material scatters and becomes highly aerated. Severe dust releases occur in the air during violent impact with the wall of the transition device. In this and other applications, it is permissible for the chute to accept at least some of the material(s) below the top of the chute.

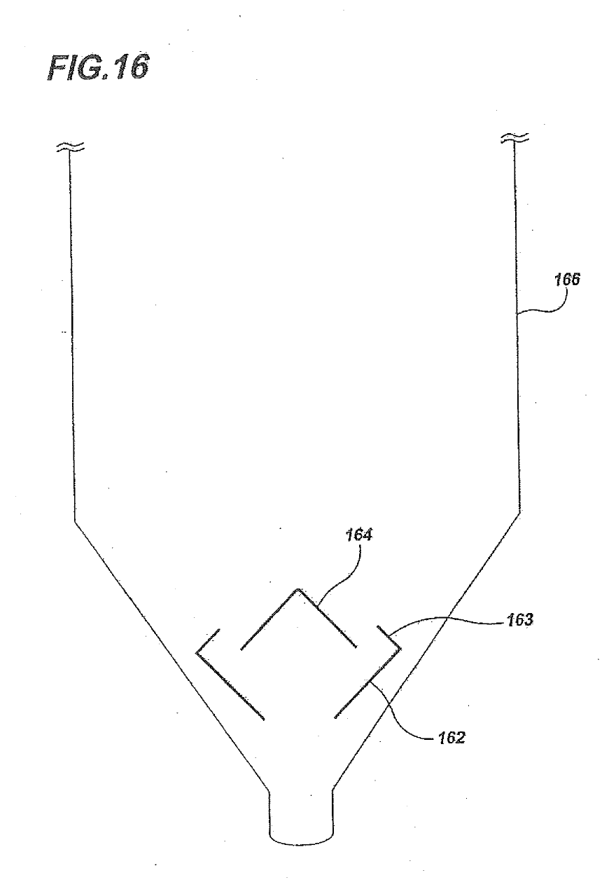

FIG. 16 depicts a single combination of a converging cone 162 with a top reverse deflector cone 163 and diverging cone 164 at the point of discharge of a bin or container 166. The cone set or combination is positioned in the storage container close to the discharge point such that flow in the container is converted from a funnel flow pattern to a mass flow pattern.

A switchback chute constructed so that it is flexible may be caused to curve a limited amount by a suitable means, such as a pull rope attached near the bottom of the chute, enabling the discharge end of the chute to be repositioned during container filling for a more even fill and to reach otherwise inaccessible areas. This feature is beneficial when the angle-of-repose prevents the material from reaching the walls of the container and significant storage capacity is lost. In this application, the switchback chute can be kept just above and clear of the pile during container filling if desired. Alternatively, the discharge end of the chute could be repositioned through the pile if it is not buried too deeply.

The switchback chute may also be used for gentle letdown of slurries with minimal segregation and splashing, and for gentle letdown of liquids with minimal velocity, splashing and foaming. An example where the controlled liquid letdown conveying features of the chute could be used is in a processing plant where pressure and/or velocity of the falling fluid must be minimized. The switchback chute may also be used as a roof drain downspout.

The switchback chute provides a very large total surface area of exposure to the air for the surfaces of solid bulk materials or liquids traversing the chute, enabling the chutes to be used as cooling towers and bulk material driers and/or heaters. In addition, for cones made of heat-conductive material, the large surface area of the cones provides for significant heat loss or cooling of the transported material. Conversely, the cones may be used for heating the bulk materials or liquids via radiation, conduction, and convection, or any combination thereof. Importantly, the switchback chute provides these heating, drying, and cooling functions while still performing its basic anti-segregation function, and its dust and damage control functions. Heating or cooling may be provided from a source that is external to the chute, for example, with coiled tubing designed for these purposes. Heated or cooled fluid may be passed through the coils. FIG. 4 shows a heating/cooling coil 49A in association with the lower cone 49 of the switchback chute.

Dusting Prevention And Control

The switchback chute provides many preventative and correction mechanisms for dusting. It maintains particle velocity at a low level. It contains the material and keeps it together. Fine particles may tend to become loose from the stream of material as the stream transverses down the chute. The switchback chute contains and confines the loose fine particles within the boundaries of the chute so that when the particles fall and settle out, they rejoin the main stream.

Additionally, the action of the Top Reverse Deflectors that redirects dust and other stray flow back towards the center of the converging cones prevents their permanent separation or segregation from the main stream. The small amount of very fine dust that escapes out of the chute advantageously spreads and settles out fairly uniformly and blends into the pile at a steady rate.

Since the switchback chute also prevents heavy particles from attaining high speeds, the fine particles in the pile are effectively protected from further fluidization segregation that would occur if subjected to explosive collisions from heavy high-speed particles. Consequently, the typical deep layer of fine particles on top of the pile is eliminated.

The design of the switchback chute ensures that only minor, localized amounts of segregation can develop within the chute. The switchback chute's many self-correction processes restore the material to a non-segregated state. The switchback chute has the ability to improve the mixing of the source material when the areas of discontinuity are reasonably small and closely spaced.

The simplicity of the switchback chute is beneficial to those of skill in the art. It is not motorized and does not require sensors, an automation control system, or a human operator, and has no moving components that could jam or wear out as may happen with extensible and retractable chutes as they are telescoped down and up during operations. Simplicity leads to low cost, easy construction and installation, and reliability of operation.

The switchback chute is adaptable to a great many types of letdown and/or mixing applications for a variety of different materials including liquids and slurries. This makes the switchback chute useful in many potential applications other than container filling, such as mixing and blending, and for material drying and cooling.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1-5. (canceled)

6. A chute for conveying bulk material or liquid from a higher location to a lower location, said chute comprising:
a plurality of converging cones truncated with openings at top and bottoms, each of said converging cones having an inner surface, an apex pointing downwards, and a first apex angle;
a first set of diverging cones, each diverging cone corresponding to one of said plurality of converging cones, said diverging cones having an outer surface, an apex pointing upwards, and a second apex angle;
said converging and diverging cones vertically aligned and arranged in alternating downwards and upwards directions with one cone below the next, each of said diverging cones spaced from said converging cone inner surface, said bulk material or liquid transiting said chute follows a path formed by said converging cone inner surface and said diverging cone outer surface, and substantially slows down or stops forward motion when contacting each subsequent cone, changes direction, and continues down said chute;
a set of top reverse deflector cones truncated on top and bottom and in peripheral contact with the top of one or more of said converging cones to contain dust and overflow material; and
a support structure for vertically aligning and securing in place said converging cones and said first and second sets of diverging cones, said structure peripherally open to said container.

7. The chute of claim 6 wherein said first apex angle and said second apex angle are in combination with one another such that a projection of said converging cone inner surface plane intersects with and is approximately perpendicular to a next lower diverging cone outer surface or a projection of said next lower diverging cone outer surface, and a projection of said diverging cone outer surface plane intersects with and is approximately perpendicular to a next lower converging cone inner surface or a projection of said next lower converging cone inner surface.

8. The chute of claim 6 wherein a diverging cone begins at said chute's top, with converging and diverging cones placed in alternating fashion down said chute.

9. The chute of claim 6 wherein at least one of said diverging cones are truncated at said diverging cone's apex.

10. The chute of claim 6 wherein said top reverse deflector cones have a third apex angle such that said inner surface of each of said converging cones is substantially perpendicular to each of said top reverse deflector cones.

11. The chute of claim 6 wherein said cones are made from a plastic, a metal, or a composite material.

12. The chute of claim 6 wherein at least one diverging cone has a top point located within a bottom hole of a corresponding upper, truncated converging cone.

13. The chute of claim 6 wherein at least one diverging cone has a bottom end located within a plane corresponding to a top hole of a corresponding lower, truncated converging cone.

14. The chute of claim 6 wherein an upper converging cone includes a shroud to prevent overflow.

15. The chute of claim 6 including a dust containment skirt attached on or near the upper periphery of at least one converging cone, said skirt fabricated from flexible material or rigid strips flexibly attached.

16. The chute of claim 15 wherein said skirt further comprises a sheet of said flexible material partially slit into strips, said sheet wrapped peripherally around and attached to said at least one converging cone.

17. The chute of claim 15 wherein said skirt further comprises individual strips of said flexible material attached to said at least one converging cone around said at least one converging cone periphery.

18. The chute of claim 17 wherein said individual strips are attached in an overlapping fashion about said periphery of said at least one converging cone.

19. The chute of claim 6 further comprising at least one truncated converging cone, pointed downwards and having a fourth apex angle, and correspondingly supported about at least one of said plurality of converging cones and above a next lower diverging cone.

20. The chute of claim 6 wherein at least some of said cones include heating or cooling elements to heat or cool said bulk material or liquid during transit.

21-34. (canceled)

35. A chute for conveying bulk material from a higher location to a lower location, said chute comprising:
a first set of flat plates, each having an inner surface, and angled in a first direction to direct said bulk material;
a second set of flat plates, each corresponding to one of said first set of flat plates, said second set of flat plates angled in a second direction opposite said first direction to direct said bulk material in an opposite direction from said first direction;
said flat plates aligned and arranged in alternating first and second directions with one plate below the next, such that a projection of a flat plate in said first direction intersects with and is approximately perpendicular to a next lower flat plate in said second direction, and a projection of said flat plate in said second direction intersects with and is approximately perpendicular to a next lower flat plate in said first direction, said bulk material transiting said chute follows a path formed by said first and second set of flat plates, and substantially slows down or stops forward motion when contacting each subsequent plate, changes direction, and continues down said chute; and
a support structure for vertically aligning and securing in place said first and second sets of plates, said structure partially open to said container.

36. The chute of claim 35 further including a third set of flat plates in contact with the top of one or more of said second set of flat plates to contain dust and overflow material.

37. The chute of claim 35 further including a second chute comprising converging and diverging cones located below said first chute to continue the conveying of falling bulk material.

38-40. (canceled)

41. A combination of two cones at the discharge point of a bin, said combination comprising:
a first diverging cone having an outer surface, an apex pointing upwards, and a first apex angle;
a converging cone truncated with openings at top and bottom, said converging cone having an inner surfaces an apex pointing downwards, and a second apex angle;
said diverging and converging cone vertically aligned with one cone below the next, such that a projection of one cone's surface plane is approximately perpendicular to a lower cone's surface or a projection of said lower cone's surface, such that bulk material transiting said combination follows a path formed by said converging cone inner surface and said diverging cone outer surface, and substantially slows down or stops forward motion when contacting the lower cone, changes direction, and continues downwards out the lower cone;
a second diverging cone truncated on top and bottom and in peripheral contact with the top of said converging cone; and
a support structure for vertically aligning and securing in place said converging cone and said diverging cones.
